(19) United States
(12) Patent Application Publication
(10) Pub. No.: US 2022/0221003 A1
(43) Pub. Date: Jul. 14, 2022

(54) METHOD FOR MACHINING A BEARING RING AND FOR PRODUCING A ROLLING BEARING

(71) Applicant: Schaeffler Technologies AG & Co. KG, Herzogenaurach (DE)

(72) Inventors: Martin Buschka, Herzogenaurach (DE); André Kuckuk, Gunzenhausen (DE); Silvio End, Heroldsberg (DE)

(73) Assignee: Schaeffler Technologies AG & Co. KG, Herzogenaurach (DE)

(21) Appl. No.: 17/608,511

(22) PCT Filed: Apr. 15, 2020
(86) PCT No.: PCT/DE2020/100297

§ 371 Date: Nov. 3, 2021

(30) Foreign Application Priority Data
May 9, 2019 (DE) 10 2019 112 061.6

(51) Int. Cl. F16C 33/64

(52) U.S. Cl. CPC F16C 33/64

(57) ABSTRACT

A method for machining a bearing ring of a rolling bearing includes providing a blank with an annular surface for producing the bearing ring, clamping the blank in a machine tool, and structuring the annular surface by high-feed milling to form a sealing face. The method may include removing material from the blank to produce a track of the bearing ring while the blank is still clamped in the machine tool, with the blank rotating during the steps of structuring the annular surface and removing material from the blank. The method may also include providing a high-feed milling cutter with a face, and performing the high-feed milling with the face.

### CROSS-REFERENCE TO RELATED APPLICATIONS

This application is the United States National Phase of PCT Appln. No. PCT/DE2020/100297 filed Apr 15, 2020, which claims priority to German Application No. DE102019112061.6 filed May 9, 2019, the entire disclosures of Which are incorporated by reference herein.

### TECHNICAL FIELD

The present disclosure relates to a method for machining a rolling bearing ring. The disclosure further relates to a method for producing a rolling bearing as well as a rolling bearing, e.g., a wheel bearing.

### BACKGROUND

U.S. 2010/0052262 A1 describes a sealing device provided for a wheel bearing, including an elastic sealing element and a metallic stop element. The stop element here has a surface machined by shot blasting treatment.

### SUMMARY

The method according to the disclosure for machining a bearing ring of a rolling bearing includes the following features: clamping a blank provided for the production of the bearing ring in a machine tool, structuring an annular surface of the bearing ring that forms a sealing face by high-feed milling.

An annular blank provided for the production of the bearing ring is clamped in a machine tool, for example a milling machine, but a non-rotating arrangement of the blank is also possible as an alternative to rotating the blank. An annular surface of the bearing ring that forms a sealing face is strictured by high-feed milling.

High-feed milling, also known as HFM (high-feed milling), enables high cutting performance at the same time having high-feed rates and cutting speeds. The high-performance milling cutters used here have a special cutting edge geometry with several cutting edges. They are available with and without indexable inserts. The use of high-feed milling to generate the sealing face enables a specific adjustment of the surface structure and surface roughness, so that friction between the seal and the sealing face can be specifically adjusted and minimized.

The publication “High-feed milling for structuring tool surfaces for sheet metal forming,” Dennis Freiberg, ISBN 978-3-8027-8912-0, Vulkan Verlag, 03/2019, shows the possibilities of high-feed milling to influence the surfaces formed therewith.

Different processing parameters during high-feed milling are responsible for the appearance and the respective roughness depths achieved for each surface structuring. Machining parameters include, for example, a feed direction of the high-feed milling cutter, a feed or cutting speed of the high-feed milling cutter, an angle of incidence of an axis of rotation of the high-feed milling cutter with respect to the surface to be machined, and a cutting depth of the high-feed milling cutter. Another optional machining parameter here is a speed of rotation of the workpiece or bearing ring to be machined by high-feed milling.

An example cutting speed for metals is about 50 to 300 m/min, depending on the type of metal (brittle or tough). The setting of a cutting depth (axial infeed) for the high-feed milling cutter may be in the range from 1 to 500 μm.

The sealing face formed by the structured surface of the bearing ring and the elastic sealing element has low friction and low susceptibility to wear while at the same time having a good sealing effect. The sealing effect relates both to the retention in the rolling bearing of lubricant, i.e., grease or oil, and to keeping dirt away from the interior of the rolling bearing.

The high-feed milling may be carried out by means of a face of a high-feed milling cutter (=face milling). This makes it possible to set the high-feed milling cutter at an angle or setting angle with regard to the surface to be machined. The face may be guided in an aligned manner at an angle β_{f} of 0 to 10° with respect to the surface of the bearing ring forming the sealing face.

In the same clamping in which the surface of the bearing ring forming a sealing face is structured, a track of the bearing ring may be produced by cutting, and the blank may rotate during the two mentioned machining steps. Alternatively, however, it is of course also possible to process the bearing ring separately to form the track and the sealing face(s), that is to say in different clamping. In this case, spatially separate and/or different machine tools can also be used to form the track and to form the sealing face(s).

If the structuring and consolidating of the sealing face takes place while the workpiece is rotating, at least one roller body track of the bearing ring is machined, i.e., by turning and/or grinding in an example method in the same setting with a rotating blank, i.e., workpiece. An example rotation speed for the workpiece to be machined, here a bearing ring, depends on the diameter of the workpiece to be machined, the milling cutter position and the surface structure to be achieved.

On the one hand, efficient and precise machining is favored by the fact that the structured surface of the bearing ring is generated in the same setting in which the machining of the bearing ring also takes place. On the other hand, no separate element is required to produce a sealing contact, for example in the form of a stop disk to be connected to a bearing ring or a thrust ring. Rather, within the rolling bearing, the elastic sealing element fastened to one of the bearing rings makes direct contact with the high-feed milled sealing face of the other bearing ring. This not only minimizes the number of parts compared to conventional solutions, but also tends to minimize the space required by the rolling bearing.

In an example embodiment of the method, during the high-feed milling, the high-feed milling cutter used is displaced relative to the bearing ring in the axial direction thereof. Alternatively, during the high-feed milling, the high-feed milling cutter is shifted relative to the bearing ring in the radial direction thereof.

This displacement of the machining tool describes, for example, a spiral line, a helical line, or a wavy line that intersects itself multiple times on the machined surface. In any case, at the end of the machining process, depressions that were produced on the machined surface provided as a sealing face are distributed approximately uniformly, expressed as the number of depressions per unit area.

Thus it has proven itself in the course of high-feed milling, for the high-feed milling cutter to describe a helical line or a spiral line on the surface to be structured. Alternatively, in the course of high-feed milling, the high-feed milling cutter may describe a multiply intersecting wavy line on the surface to be structured. In this way, a wide variety of surface structures and surface roughness can be set for the sealing face, which can be tailored to the specific application and the requirements thereof.

At least one smoothing post-treatment process may be used in the area of the surfaces of the sealing face(s) formed by high-feed milling. Brushing, blasting, etching or the like are suitable as post-treatment methods. As a result, burrs or sharp edges are reduced in the area of the surfaces of the sealing face(s) formed by high-feed milling, which leads to a longer service life of the seal contacting the sealing face. The risk of damage to or roughening of the seal on the contact surface thereof with the sealing face is reduced.

The method for producing the rolling bearing includes the following steps:

provision of a bearing ring with a surface structured by means of high-feed milling as a sealing face and a further bearing ring,

placement of a number of roller bodies between the bearing rings, and

installation of a seal between the bearing rings effective in such a way that it is held on the further bearing ring and comes into contact with the structured surface.

The sealing face foamed by the structured surface of the bearing ring and the elastic sealing element has low friction and low susceptibility to wear while at the same time having a good sealing effect. The sealing effect relates both to the retention in the rolling bearing of lubricant, i.e., grease or oil, and to keeping dirt away from the interior of the rolling bearing.

The rolling bearing according to the disclosure includes at least two bearing rings, between which a number of roller bodies are arranged, and with at least one seal which is held on one of the bearing rings and contacts a high-feed milled surface of the other bearing ring.

Balls as well as needles or rollers, for example cylindrical rollers, barrel roller, or tapered rollers, can be provided as roller bodies of the rolling bearing. The rolling bearing can be designed as a single- or multi-row bearing and comprises two bearing rings or a larger number of bearing rings, for example three bearing rings. For example, the rolling bearing may be a wheel bearing for a motor vehicle.

For example, the structured surface, that is to say the high-feed milled sealing face, may have depressions with a roughness depth Rₜ of a maximum of 100 μm. This ensures a sealing effect of the seal is maintained, which runs up against the structured surface or sealing face, and at the same time brings about an optimization with regard to the friction occurring therebetween. A roughness depth Rₜ of the stnictured surface of a maximum of 10 μm may be selected. A roughness depth Rₜ in the range from 3 μm to 5 μm, for example, may be selected.

While one of the bearing rings of the rolling bearing in the region of the sealing face is machined by high-feed milling, the other bearing ring is generally not provided with such machining. The rolling bearing can be sealed either on one side or on both sides. Each of the bearing rings can either be a one-piece or a split bearing ring.

In typical configurations, the bearing ring of the rolling bearing, which is machined through high-feed milling, is the inner ring. Either the inner ring or the outer ring can be provided as the rotating bearing ring. Accordingly, the bearing ring with the high-feed milled sealing face can in principle be both an inner ring and an outer ring.

### BRIEF DESCRIPTION OF THE DRAWINGS

Below, two exemplary embodiments of the disclosure are explained in more detail through a drawing. In the figures:

FIG. 1 shows a schematic representation of the machining of a surface of a bearing ring through high-feed milling,

FIG. 2 shows a perspective view of the bearing ring machined with the method according to FIG. 1,

FIG. 3 shows a rolling bearing designed as a deep groove ball bearing including the bearing ring according to FIG. 2,

FIG. 4 shows a section of a rolling bearing designed as a wheel bearing with a bearing ring to be machined according to FIG. 1, and

FIG. 5 shows different surface structurings formed by means of high-feed milling on surfaces made of a metallic material.

### DETAILED DESCRIPTION

Unless otherwise stated, the following explanations relate to all exemplary embodiments. Parts or structures that correspond to each other or have basically the same effect are marked with the same reference symbols in all figures.

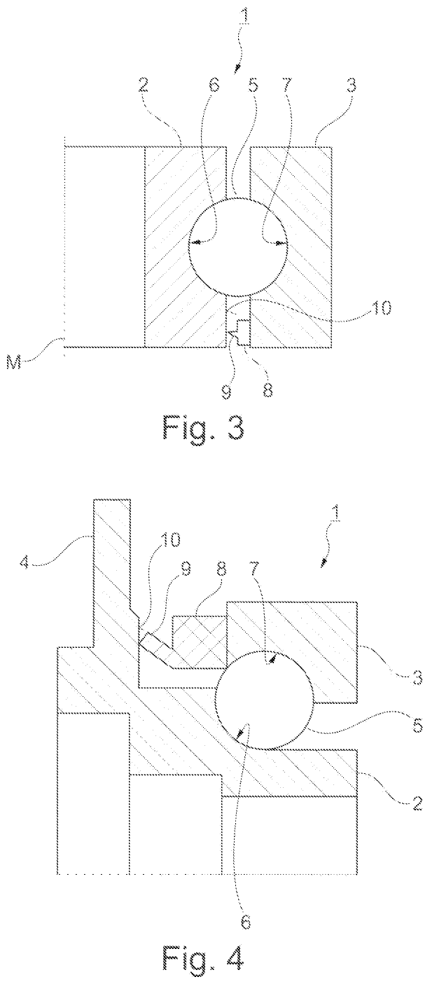

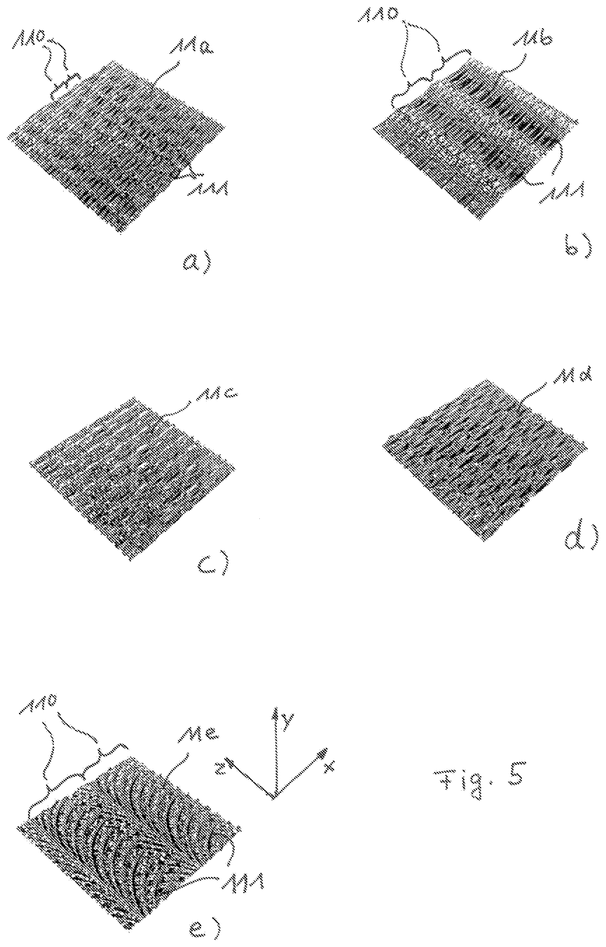

A rolling bearing identified overall with the reference number 1 is designed as a ball bearing and comprises an inner ring 2 and an outer ring 3 (compare FIG. 3). The rolling bearing 1 shown in FIG. 3 is a deep groove ball bearing, while the rolling bearing 1, only partially sketched in FIG. 4, is a two-row angular ball bearing, namely a wheel bearing for a motor vehicle. In this case, a flange of the inner ring 2 is denoted by 4.

In both cases, balls roll as roller bodies 5 between the bearing rings 2, 3. The roller bodies 5 can be guided in a cage, not shown. A track 6 of the inner ring 2 contacting the roller bodies 5 and a track 7 of the outer ring 3 contacting the roller bodies 5 can be seen.

A seal 8, which has a sealing lip 9, is held on the outer ring 3. The sealing lip 9 comes into contact with a surface 10 of the inner ring 2 which, in the case of FIG. 3, describes a concentric cylinder which is parallel to the central axis M of the rolling bearing 1. In the case of FIG. 4, on the other hand, the surface 10 lies on a plane which is oriented to be normal to the central axis M. In both cases, the seal 8 is a contact seal. In a manner not shown, the seal 8 can have more than one sealing lip 9.

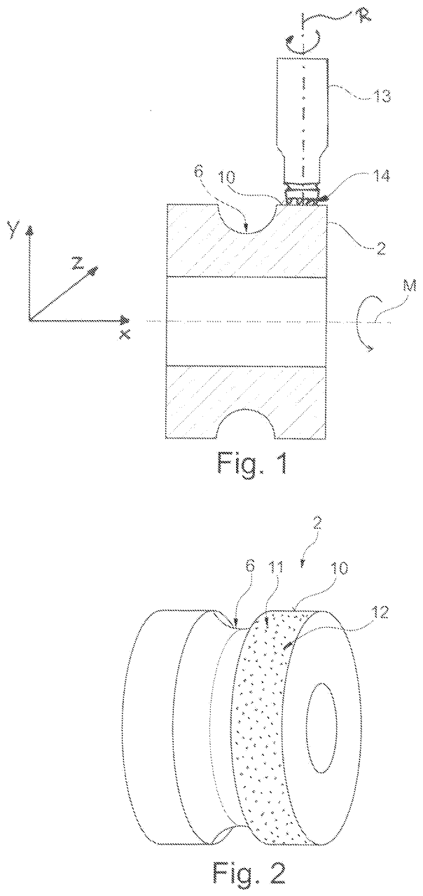

The surface 10, which is contacted by the sealing lip 9, is structured by means of high-feed milling which is illustrated in FIG. 1 and provides a surface structuring 11. This method is used in the production of the inner ring 2 of the rolling bearing 1 according to

FIG. 3 as well as in the production of the inner ring 2 of the rolling bearing 1 according to FIG. 4, A smooth finishing of the surface 10 provided as a sealing face after the high-feed milling does not take place.

To produce the inner ring 2, a blank, the basic shape of which corresponds to the shape of the later inner ring 2, is clamped into a machine tool, not shown, e.g., a milling machine. During the following processing, the blank, that is to say the later inner ring 2, rotates about the central axis M thereof at a cutting speed vₑ. The machining of the blank while it is clamped in the machine tool includes machining of the roller body track 6.

In the example sketched out in FIGS. 1 to 3, the rolling bearing 1 is only sealed on one side. Accordingly, the rolling bearing 1 has only a single cylindrical surface 10, Which functions as a sealing face within the fully assembled rolling bearing 1 (FIG. 3). The surface structuring 11 of the surface 10 indicated in FIG. 2 is also given in the exemplary embodiment according to FIG. 4. The surface structuring 11 has the form of numerous depressions 12. The roughness depth Rₜ of the structured surface 10 here is in the range from 3 to 5 μm.

A tool 13 in the form of a high-feed milling cutter 14 is used to produce the depressions 12. The tool 13 is installed on the machine tool.

The high-feed milling cutter 14 can be oriented in an XYZ coordinate system (see FIG. 1) in relation to the central axis M in the XY plane and/or in an angled manner, seen in the YZ plane. The high-feed milling cutter 14 is advanced axially in the direction of the Y-axis, that is, material is removed by being advanced in the direction of the axis of rotation M.

To produce the surface structuring 11 of the inner ring 2 according to FIG. 4, the tool 13 is, for example, moved slowly and evenly radially from the inside to the outside or from the outside to the inside, The depressions 12 thus generated theoretically lie on a spiral line. If, on the other hand, the tool 13 is moved with a comparatively high frequency between a first extreme point, which lies radially inward, and a second extreme point, which represents the radially outer boundary of the surface 10, then those waveforms of the surface structuring 11 arise first which lie in a single plane, namely the plane of the surface 10. In the course of several revolutions of the inner ring 2, these waves overlap several times, in principle comparable to the exemplary embodiment according to FIG. 1, so that also in this case a high uniformity is achieved in the distribution of the depressions 12 within the surface 10.

FIG. 5 shows in the representations 5 a)-5 e) five different surface structurings 11a to 11e formed by means of high-feed milling on flat surfaces made of metallic material, in particular steel. Different machining parameters during high-feed milling are responsible for the appearance and the respective roughness depths achieved of each surface structuring 11a to 11e. For each surface structuring 11a to 11e, the parameters cutting speed vₑ, axial infeed a_{c}, radial infeed aₚ, feed per tooth f_{z} and setting angle β_{f} are given below, which were used to form them with identical milling cutters.

FIG. 5a):
v_{c}=100 m/min
aₑ=1 mm
aₚ=100 μm
f_{z}=0.05 mm
β_{f}=0.1°

FIG. 5b):
v_{c}=100 m/min
aₑ=3 mm
aₚ=100 μm
f_{z}=0.3 mm
β_{f}=5°

FIG. 5c):
v_{c}=100 m/min
aₑ=1 mm
aₚ=100 μm
f_{z}=0.1 mm
β_{f}=0.1°

FIG. 5d):
v_{c}=100 m/min
aₑ=1 mm
aₚ=100 μm
f_{z}=0.15 mm
β_{f}=0.1°

FIG. 5e):
v_{c}=100 m/min
aₑ=1 mm
aₚ=100 μm
f_{z}=0.3 mm
β_{f}=0.5°

The appearance of a sealing face can be designed in such a way that parallel processing tracks 110 of a high-feed milling cutter 14 are shown in a longitudinal structure that runs in the direction of the feed direction, with arc-shaped or partially circular milling tracks 111 within such a processing track 110 as a transverse structure, which essentially is formed perpendicular to the longitudinal structure, can be seen [compare FIGS. 5a), 5b), and 5e)]. However, more uniform surface structurings that do not show a pronounced longitudinal structure can also be produced [compare FIGS. 5c), 5d)].

The XYZ coordinate system, which is shown as an example for illustration 5e), is intended to clarify the machining parameters. The cutting speed v_{c} is given in the cutting direction along the Z-axis, the axial infeed aₑ is given in the direction of the Y-axis, the radial infeed aₚ is given in the direction of the X-axis, the feed per tooth is f_{z} indicated in the direction of the Z-axis, and the angle of incidence β_{f} of the axis of rotation R of the high-feed milling cutter 14 (see FIG. 1) is indicated with respect to the XZ plane.

Through a few experiments with variation of the machining parameters during high-feed milling, different surfaces that are suitable for use as surface structuring for a sealing face can be generated. It should be noted, however, that different designs of the milling cutter used with regard to the number of cutting edges (or number of teeth) and cutting edge arrangement also have an influence on the surface structure achieved. Using the same processing parameters, but different milling cutter geometries, different surface structures are achieved. However, the average person skilled in the art is easily able to find suitable surface structures for sealing faces of bearing rings with the aid of a few experiments while changing the machining parameters during high-feed milling with a given milling cutter.

### REFERENCE NUMERALS

1 Rolling bearing

2 Inner ring

3 Outer ring

4 Flange

5 Roller body

6 Track of the inner ring

7 Track of the outer ring

8 Seal

9 Sealing lip

10 Surface

11, 11a-e Surface structuring

110 Processing track

111 Milling track

12 Depression

13 Tool

14 High-feed milling cutter

M Central axis

R Axis of rotation

X X coordinate

Y Y coordinate

Z Z coordinate

1.-11. (canceled)

12. A method for machining a bearing ring of a rolling bearing, comprising:
providing a blank with an annular surface for producing the bearing ring;
clamping the blank in a machine tool; and
structuring the annular surface by high-feed milling to form a sealing face.

13. The method of claim 12, further comprising removing material from the blank to produce a track of the bearing ring while the blank is still clamped in the machine tool, wherein the blank rotates during the steps of structuring the annular surface and removing material from the blank.

14. The method of claim 12, further comprising:
providing a high-feed milling cutter with a face; and
performing the high-feed milling with the face.

15. The method of claim 14, further comprising guiding the face in an aligned manner at an angle of 0 to 10° with respect to the annular surface.

16. The method of claim 14, wherein the step of structuring the annular surface by high-feed milling comprises displacing the high-feed milling cutter in an axial direction of the blank during the high-feed milling.

17. The method of claim 16, wherein the high-feed milling cutter describes a helical line or a spiral line on the annular surface during the step of structuring the annular surface by high-feed milling.

18. The method of claim 16, wherein the high-feed milling cutter describes a wavy line that intersects itself multiple times on the annular surface during the step of structuring the annular surface by high-feed milling.

19. The method of claim 14, wherein the step of structuring the annular surface by high-feed milling comprises displacing the high-feed milling cutter in a radial direction of the blank during the high-feed milling.

20. The method of claim 19, wherein the high-feed milling cutter describes a helical line or a spiral line on the annular surface during the step of structuring the annular surface by high-feed milling.

21. The method of claim 19, wherein the high-feed milling cutter describes a wavy line that intersects itself multiple times on the annular surface during the step of structuring the annular surface by high-feed milling.

22. A method for producing a rolling bearing, comprising:
providing a first bearing ring produced using the method of claim 12;
providing a second bearing ring, a plurality of roller bodies, and a seal;
installing the plurality of roller bodies between the first bearing ring and the second bearing ring; and
installing the seal on the second bearing ring such that the seal contacts the sealing face of the first bearing ring.

23. A rolling bearing, comprising:
a first bearing ring comprising a high-feed milled surface;
a second bearing ring;
a plurality of roller bodies arranged between the first bearing ring and the second bearing ring; and
a seal, held on the second bearing ring and contacting the high-feed milled surface.

24. A wheel bearing comprising the rolling bearing of claim 23.
